(19) United States
(12) Patent Application Publication
(10) Pub. No.: US 2026/0081334 A1
(43) Pub. Date: Mar. 19, 2026

(54) THERMALIZED POCKETED CRYOGENIC CIRCULATOR WITH GROUND TUNING

(71) Applicant: Google LLC, Mountain View, CA (US)

(72) Inventors: George Earl Grant Sterling, Santa Barbara, CA (US); Sebastian Xavier Schroeder, Santa Barbara, CA (US); John Edward Beck, Goleta, CA (US)

(21) Appl. No.: 18/595,795

(22) Filed: Mar. 5, 2024

(51) Int. Cl. H01P 1/387; G06N 10/20; G06N 10/40

(52) U.S. Cl. CPC H01P 1/387; G06N 10/20; G06N 10/40

(57) ABSTRACT

Abstract

[symbol]

### FIELD

The present disclosure relates generally to systems and methods for quantum computing.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a |0 [symbol] +b |1 [symbol] The “0” and “1” states of a digital computer are analogous to the |0 [symbol] and |1 [symbol] basis states, respectively of a qubit.

### SUMMARY

Aspects and advantages of embodiments of the present disclosure will be set forth in part in the following description, or can be learned from the description, or can be learned through practice of the embodiments.

Example aspects of the present disclosure provide an example stripline circulator. In some implementations, the example stripline circulator can include a first ground structure having one or more cavities. In some implementations, the example stripline circulator can include one or more dielectrics inside the one or more cavities. In some implementations, the example stripline circulator can include at least one center conductor. In some implementations, the example stripline circulator can include a first port. In some implementations, the example stripline circulator can include a second port. In some implementations, the example stripline circulator can include a third port. In some implementations, the example stripline circulator can be characterized by non-reciprocal signal transmission behavior. In some implementations, the non-reciprocal signal transmission behavior can comprise the second port providing, responsive to a first signal being provided as an input signal to the first port, the first signal as an output signal. In some implementations, the non-reciprocal signal transmission behavior can comprise the third port providing, responsive to a second signal being provided as the input signal to the second port, the second signal as the output signal.

Example aspects of the present disclosure provide an example quantum computing system. In some implementations, the example quantum computing system can include an example stripline circulator. In some implementations, the example stripline circulator can include a first ground structure having one or more cavities. In some implementations, the example stripline circulator can include one or more dielectrics inside the one or more cavities. In some implementations, the example stripline circulator can include at least one center conductor.

Example aspects of the present disclosure provide an example method for tuning a stripline circulator. In some implementations, the example method can include adjusting a contact pressure between a first ground structure of the stripline circulator and a second ground structure of the stripline circulator, such that an impedance between the first ground structure and the second ground structure is increased or reduced.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1A depicts a three-quarter profile view of an example ground plane component of an example stripline circulator according to aspects of the present disclosure;

FIG. 1B depicts a top-down view of an example ground plane component of an example stripline circulator according to aspects of the present disclosure;

FIG. 2 depicts a top-down view of portions of an example stripline circulator according to aspects of the present disclosure;

FIG. 3 depicts a top-down view of portions of an example stripline circulator according to aspects of the present disclosure;

FIG. 4 depicts a schematic diagram of an example isolation circuit according to aspects of the present disclosure;

FIG. 5 depicts an example of a quantum computing system according to example aspects of the present disclosure;

FIG. 6 depicts a flow chart diagram of an example method for operating a quantum computing system according to example aspects of the present disclosure.

### DETAILED DESCRIPTION

As used herein, the terms “about” or “approximately” in conjunction with a numerical value refer to within 10% of the stated amount.

Example embodiments according to some aspects of the present disclosure are directed to precision circulators for microwave signals and/or radio-frequency electromagnet (EM) signals. The precision circulators of the embodiments may be employed, for instance, in quantum computing systems. More specifically, the circulators may be employed to route and/or isolate microwave and/or radiofrequency (RF) signals generated in quantum computing systems (e.g., qubit control and/or qubit readout signals). Precision circulators of the embodiments may be operable within a cryogenic system (e.g., a cryogenic system within a quantum computer) or within other microwave or RF systems that require circulators for signal routing or signal isolation. One general property of circulators of the embodiments includes non-reciprocal signal routing and signal isolation. Such non-reciprocal devices provide an asymmetry in the direction of flow of an EM signal.

At least some of the embodiments are directed to stripline circulators. A stripline circulator can include, for example, a center conductor for transmitting an EM signal. The center conductor can include, for example, a central junction portion and three “arms.” In some instances, the central junction portion of a center conductor can be sandwiched between two ferrites. Each arm of the center conductor can be sandwiched, for example, between two dielectrics. The ferrites, dielectrics, and center conductor can in some instances be sandwiched between two ground structures.

In some implementations, one or both ground structures can include one or more cavities. In some implementations, a shape of the cavities can be similar to (e.g., same as) a combined shape of the dielectrics, ferrites, and center conductor. For example, in some implementations, a circulator can include two ferrites, each shaped as a round disk. In some implementations, a circulator can include six dielectrics, each shaped as a rectangular prism. In such instances, each ground structure can include a cavity comprising a central disk-shaped cavity and three rectangular-prism-shaped “arm” cavities. Other ferrite and dielectric shapes are possible. In some implementations, the dielectrics, ferrites, and center conductor can be inserted in the cavity along with a compliant layer of vacuum grease or other suitable lubricant, which can offer full contact to the entire surface areas of the dielectrics, ferrites, and center conductor for better thermalization in a cryogenic environment.

In some implementations, each arm can be sandwiched between a first dielectric and a second dielectric, with a length of the first dielectric being different from a length of the second dielectric. In this manner, for instance, a portion of the center conductor can be exposed to enable soldering of an electrical contact to the center conductor. In some implementations, a width of the center conductor can be adjusted to compensate for a different dielectric constant in the exposed region.

In some implementations, a circulator can include a compliant conductive gasket between the two ground structures. In some instances, the conductive gasket can be impervious to light. In this manner, for instance, a light-tight environment can be provided, and a signal transmission environment (e.g., quantum computing signal transmission environment) can be protected from, for example, millimeter-wave and infrared radiation.

In some implementations, a circulator can be tuned after assembly and installation (e.g., after installation in a cryogenic quantum computing system). For example, in some instances, a circulator comprising a compliant gasket can be tuned by adjusting a contact pressure between the ground structures, thereby adjusting an impedance between the ground pieces. In some instances, a contact pressure of an installed circulator can be increased or decreased merely by tightening or loosening one or more exterior screws of the circulator.

In some implementations, components of the circulator can be removable or interchangeable. For example, in contrast to alternative circulators comprising a monolithic ferrite-dielectric assembly, example circulators according to example aspects of the present disclosure can comprise a plurality of (e.g., six) removable or interchangeable dielectrics; one or more (e.g., two) removable or interchangeable ferrites; and other removable or interchangeable components.

Example embodiments according to some aspects of the present disclosure can provide for a number of technical effects and benefits, such as improvements to computing technology (e.g., quantum computing technology). In particular, example embodiments can provide improved quantum computing performance (e.g., improved isolation, reduced noise, etc.); improved tuning and assembly (e.g., reduced labor cost, improved tuning accuracy, etc.); and improved configurability (e.g., choice of materials, shapes, etc.) compared to alternative circulators.

In some instances, example circulators according to aspects of the present disclosure can provide improved quantum computing performance and/or signal isolation compared to alternative circulators. For example, in some example experiments according to the present disclosure, circulators according to examples of the present disclosure provided a 10 decibel (dB) increase in reverse isolation compared to alternative circulators. In some instances, example circulators according to aspects of the present disclosure can provide reduced thermal noise compared to alternative circulators by providing better thermalization of circulator components (e.g., dielectrics and ferrites). In some instances, example circulators according to aspects of the present disclosure can provide a light-tight (i.e., impervious to light) environment, which can reduce disruption (e.g., to sensitive quantum computing devices made with Josephson junctions) from infrared or millimeter-wave radiation. In some instances, example circulators according to aspects of the present disclosure can have a reduced cavity volume, and can therefore be associated with increased cavity mode frequencies, compared to alternative circulators. For example, in some instances, a minimum box mode of example circulators can be greater than 12 gigahertz (GHz), which can provide improved isolation in operating environments where a signal of interest is below 12 GHZ (e.g., 4-8 GHZ, etc.). In some instances, example circulators according to aspects of the present disclosure can provide reduced parasitic capacitances compared to alternative circulators, which may introduce parasitic capacitances at a tab for soldering an electrical contact to a center conductor. In some instances, example circulators can be associated with reduced scintillation compared to alternative stripline circulators. For example, mode rejection ferrites of some alternative stripline circulators can cause scintillation, whereas example circulators according to aspects of the present disclosure can in some instances be built without mode rejection ferrites.

In some instances, example circulators according to aspects of the present disclosure can provide improved tunability compared to alternative circulators. For example, tuning alternative circulators can in some instances require manual adjustment (e.g., using glue and tweezers) of internal components of the circulator, which can be highly labor-intensive and may not be feasible after a circulator is fully installed (e.g., in a cryogenic quantum computing system). In contrast, example circulators according to aspects of the present disclosure can be tuned merely by tightening or loosening an exterior actuator (e.g., screw, etc.) of the circulator, thereby enabling reduced-labor-cost in-situ tuning of a circulator. In some instances, in situ tuning of a circulator after assembly and installation can be associated with improved tuning accuracy compared to pre-assembly and pre-installation tuning of alternative circulators.

In some instances, example circulators according to aspects of the present disclosure can provide improved configurability compared to alternative circulators. For example, some embodiments can include interchangeable or removable individual components (e.g., ferrites, dielectrics, conductive gaskets, etc.). This interchangeability can facilitate, for example, experimentation with different materials and combinations of materials (e.g., ferrite materials, dielectric materials); different component shapes; and other design choices. In this manner, for instance, example circulators according to aspects of the present disclosure can enable rapid experimentation with circulator configurations to determine an optimal configuration for a particular use case.

With reference now to the Figures, example embodiments of the present disclosure will be discussed in further detail.

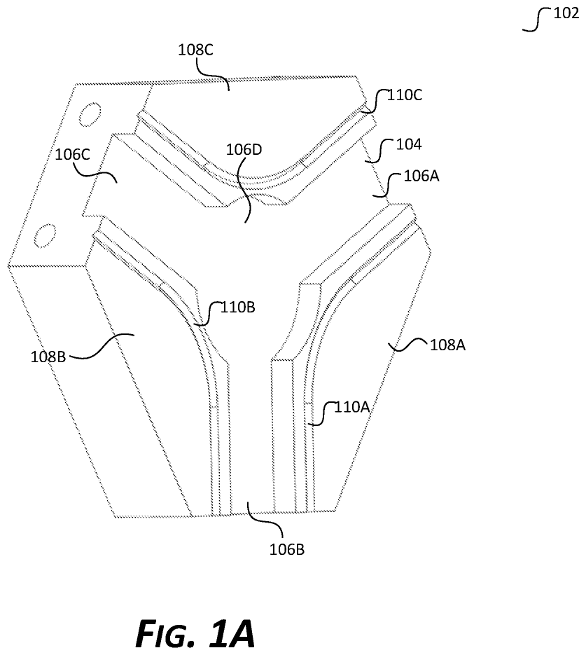

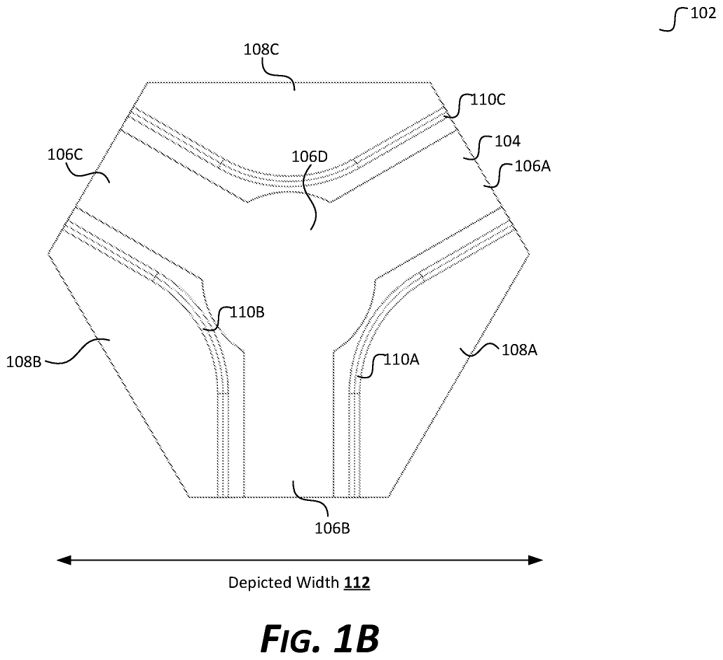

FIGS. 1A and 1B are illustrations, from different viewing angles, of an example ground structure 102 of an example stripline circulator. FIG. 1A shows a three-quarter profile view, while FIG. 1B shows a top-down view. The ground structure 102 can comprise one or more stripline cavities 104 and one or more contact surfaces 108A-C. In some instances, a cavity 104 can comprise multiple cavity sections 106A-D configured to hold particular circulator components. In some instances, the ground structure 102 can include or not include one or more gasket cavities 110A-C.

The ground structure 102 can comprise, for example, any appropriate conductive material (e.g., metal material such as copper, etc.). The ground structure 102 can be configured to be connected to a ground to provide a ground plane for a stripline assembly. In some instances, an example circulator can comprise two ground structures 102, which can be the same as or different from each other. The ground structure 102 can have a shape that is similar to (e.g., same as) or different from the shape depicted in FIGS. 1A and 1B. In some instances, a ground structure 102 can have a shape having three-way rotational symmetry (e.g., triangular, hexagonal, circular, etc.) when viewed from the top down (e.g., as depicted in FIG. 1B). In some example embodiments, FIG. 1A or 1B can be approximately to scale, and a depicted width 112 at a widest point depicted in FIG. 1B can be in a range between about 1 and about 3 inches, such as between about 1.5 and about 2.5 inches; such as between about 1.75 inches and about 2.25 inches; such as about 2 inches. Other widths and shapes are possible.

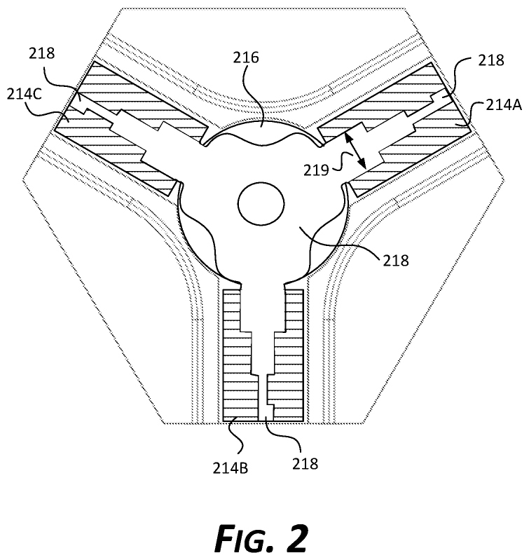

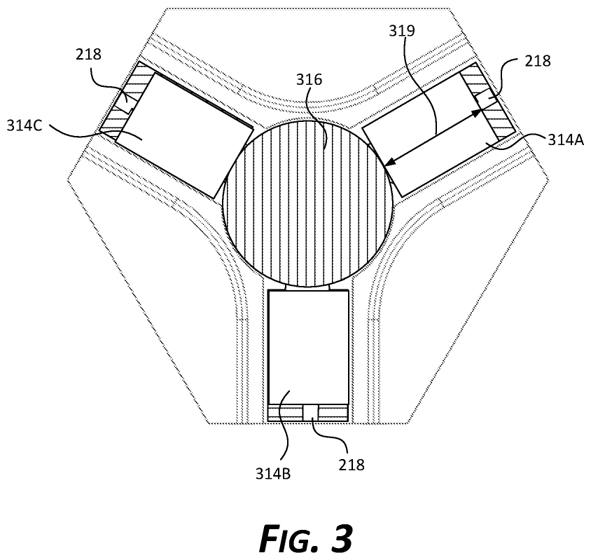

The stripline cavity 104 can have a shape that is similar to (e.g., same as) or different from the shape depicted in FIGS. 1A and 1B. In some instances, the stripline cavity 104 can be characterized by a top-facing surface that is recessed from a topmost surface (e.g., contact surfaces 108A-C) of the ground structure 102, such as a cavity, recession, groove, trench, pocket, notch, concavity, etc. In some instances, the stripline cavity 104 can comprise a central junction cavity 106D, and three arm cavities 106A-C, which can have a shape that is similar to (e.g., same as) or different from the shape depicted in FIGS. 1A and 1B. In some instances, the central junction cavity 106D can have a shape that is approximately circular (e.g., thin cylindrical disk, etc.) or not circular. In some instances, the central junction cavity 106D can have a shape having three-fold rotational symmetry when viewed from the top down as in FIG. 1B (e.g., triangular such as thin triangular prism; hexagonal; circular; etc.). In some instances, the arm cavities 106A-C can have a shape that is similar to (e.g., same as) or different from each other. In some instances, each arm cavity 106A-C can be shaped as a thin rectangular prism (e.g., three identical rectangular prisms, etc.). In some instances, the arm cavities 106A-C can be configured such that a stripline cavity 104 or ground component 102 has a shape having three-fold rotational symmetry when viewed from a top-down view (e.g., as depicted in FIG. 1B). In some instances, the cavities 104, 106A-D can have a shape configured to match a shape of one or more stripline components described below with respect to FIGS. 2-3. For example, a stripline component and corresponding cavity can be configured so that the stripline component fits snugly into a corresponding cavity with little or no gap between the stripline component and one or more cavity walls.

The contact surfaces 108A-C can have a shape that is similar to (e.g., same as) or different from the shape depicted in FIGS. 1A and 1B. In some instances, the contact surfaces 108A-C can include a topmost surface of the ground structure 102, or any top-facing surface of the ground structure 102 that is not part of one or more cavities (e.g., stripline cavity 104; gasket cavity 110A-C; etc.). The contact surfaces 108A-C can have a shape that is similar to (e.g., same as) or different from each other. For example, in some instances, the ground structure 102 and stripline cavity 104 can have three-fold rotational symmetry, wherein the contact surfaces 108A-C can have a shape that is similar to (e.g., same as) each other.

In some instances, the ground structure 102 can include or not include one or more gasket cavities 110A-C. A gasket cavity 110A-C can have a shape that is similar to (e.g., same as) or different from the shape depicted in FIGS. 1A and 1B. In some instances, a gasket cavity 110A-C can have a shape that is similar to one or more gasket components to be inserted into the gasket cavity 110A-C. In some instances, one or more compliant conductive gaskets can be inserted into gasket cavities 110A-C of a first ground structure 102. Additional circulator components can be inserted into a first and second ground structure 102 (e.g., as further described below with respect to FIGS. 2-3). The second ground structure 102 can be placed on top of the first ground structure 102, such that the compliant conductive gaskets enter the gasket cavities 110A-C of the second ground structure 102. In some instances, a compliant conductive gasket can include a wire (e.g., indium wire, etc.). In some instances, the compliant conductive gasket can comprise a material that is impervious to light (e.g., copper, indium, etc.), including millimeter-wave and infrared radiation. In some instances, a ground structure 102 can lack any gasket cavities 110A-C. In some instances, one or more compliant gaskets can be placed on top of one or more contact surfaces 108A-C. In some instances, a compliant gasket can comprise a textured foil (e.g., light-tight metal foil, etc.). For example, in some instances, a metal foil (e.g., copper foil) can be pressed into sandpaper to imprint a texture of the sandpaper onto the foil before installing the foil in a stripline circulator.

In some instances, a fully assembled circulator comprising two ground structures 102 with a compliant conductive gasket between them can be tuned by adjusting a contact pressure between the ground structures 102. For example, a contact pressure between the ground structures 102 can be adjusted to tune an impedance between the ground pieces. In some instances, a circulator can be configured to enable increasing or decreasing a contact pressure of an assembled or installed circulator merely by adjusting one or more exterior actuators (e.g., screws, knobs, clamps, clips, etc.) of the circulator. Adjusting an exterior actuator can include, for example, tightening or loosening one or more exterior screws of the circulator to increase or decrease a contact pressure between the ground pieces. An exterior actuator can include, for example, a screw, knob, clamp, clip, vice, or other device for increasing or decreasing a contact pressure between the ground pieces. In some instances, fine-grained tuning can be achieved by tightening an exterior side actuator (e.g., screw) that is orthogonal to an exterior tuning actuator (e.g., screw) for tuning an impedance, such that an amount of force required to loosen or tighten the exterior tuning actuator is increased. When such a side actuator is tightened, for instance, application of a given amount of force can cause a smaller adjustment to a contact pressure between two ground structures 102 (e.g., due to increased friction associated with the tightened side actuator), thereby providing finer-grained tuning control. In some instances, a foil gasket can provide finer-grained tuning control compared to a wire gasket, while a wire gasket can in some instances provide for easier assembly compared to a foil gasket.

FIG. 2 is a top-down view of part of an example stripline circulator, including a plurality of example stripline components inserted into a stripline cavity 104 of the example ground structure 102 of FIG. 1B. A plurality of dielectrics 214A-C can be inserted into a plurality of cavity arms 106A-C. A ferrite 216 can be inserted into a central junction cavity 106D. A center conductor 218 can be placed on top of the dielectrics 214A-C and ferrite 216. In some instances, the dielectrics 214A-C can have a shape that is similar to (e.g., same as) a shape of the arm cavities 106A-C. In some instances, the dielectrics 214A-C can have a shape that is similar to (e.g., same as) each other. The dielectrics can comprise any appropriate dielectric (e.g., insulating, nonconductive, etc.) material, such as ceramic, silicon carbide, etc. In some instances, a dielectric 214A-C can include an injectable fluid or semisolid dielectric, such as a mixture of dielectric powder (e.g., silicon carbide powder, etc.) with a fluid or semisolid medium (e.g., vacuum grease, non-scintillating monomer chain such as parafin wax, etc.). In some instances, a dielectric 214A-C can include a cavity in which the center conductor 218 can be inserted (e.g., a cavity having a shape that is approximately the same as an arm of the center conductor 218, etc.). Although FIG. 1B depicts a small gap between the dielectrics 214A-C and the side walls of the arm cavities 106A-C, this depiction is not necessarily to scale. For example, in some instances, the dielectrics 214A-C can have a shape that is very similar to a shape of the arm cavities 106A-C, such that any gap between the dielectrics 214A-C and the side walls of the arm cavities 106A-C can be smaller than depicted (e.g., less than 100 micrometers, 50 micrometers, 20 micrometers, 10 micrometers, etc.). In some instances, a gap may be larger than depicted without going outside the scope of the present disclosure. In some instances, the dielectrics 214A-C can be coated in a fluid or semisolid material such as vacuum grease (e.g., Apiezon N vacuum grease, etc.) to further provide surface contact between the dielectrics 214A-C and arm cavities 106A-C throughout a surface area of the dielectrics 214A-C. In this manner, for instance, thermalization of the dielectrics 214A-C can be facilitated or improved. Additionally, providing full surface contact can in some instances prevent unwanted changes in capacitance.

In some instances, the ferrite 216 can have a shape that is similar to (e.g., same as) a shape of the central junction cavity 106D. A ferrite 216 can comprise any appropriate ferrite material (e.g., yttrium iron garnet with aluminum dopants, etc.). A ferrite 216 can include, for example, a ceramic material comprising iron and one or more other metallic elements. A ferrite 216 can comprise, for example, a ferrimagnetic or ferromagnetic material. Although FIG. 1B depicts a small gap between the ferrite 216 and the side walls of the central junction cavity 106D, this depiction is not necessarily to scale. For example, in some instances, the ferrite 216 can have a shape that is very similar to a shape of the central junction cavity 106D, such that any gap between the dielectrics 214A-C and the side walls of the central junction cavity 106D can be smaller than depicted (e.g., less than 100 micrometers, 50 micrometers, 20 micrometers, 10 micrometers, etc.). In some instances, a gap may be larger than depicted without going outside the scope of the present disclosure. In some instances, the ferrite 216 can be coated in a fluid or semisolid material such as vacuum grease (e.g., Apiezon N vacuum grease, etc.) to further provide surface contact between the ferrite 216 and central junction cavity 106D throughout a surface area of the ferrite 216.

In some instances, a thickness measured from top to bottom (wherein FIG. 2 is a top-down view) of the ferrite 216 can be approximately equal to a thickness measured from top to bottom of one or more (e.g., all) dielectrics 214A-C. In some instances, a thickness of the dielectrics 214A-C can be, for example, approximately 0.05 inches. Thicker and thinner dielectrics 214A-C are possible. In some instances, a reduced dielectric 214A-C thickness can reduce a cavity size associated with a stripline circulator, advantageously increasing a minimum cavity mode frequency, such that unwanted noise at frequencies below the increased minimum cavity mode frequency can be eliminated or reduced. However, in some instances, a thinner (e.g., 0.025-inch, etc.) ferrite 216 can be more susceptible to error compared to a thicker ferrite 216. Thus, an optimal thickness of the ferrite 216 and dielectrics 214A-C can in some instances be dependent on one or more aspects (e.g., intended operating frequency, etc.) of a particular use case.

The center conductor 218 can comprise, for example, any appropriate conductive material (e.g., metal material such as copper, etc.). In some instances, the center conductor can have an approximately flat shape, wherein a height of the center conductor 218 in a top-to-bottom direction (wherein FIG. 2 is a top-down view) can be small (e.g., 1 millimeter, 0.5 millimeter, 2 millimeter, etc.). In some instances, a height of the center conductor 218 can be approximately constant throughout the center conductor 218. In some instances, the center conductor can comprise a central junction portion configured to be placed on top of a ferrite 216 and one or more (e.g., three) arm portions configured to be placed on top of one or more dielectrics 214A-C. In some instances, the center conductor 218 can have a shape that is similar to (e.g., same as) or different from the shape depicted in FIG. 2. For example, in some instances, each arm portion can have a non-constant width 219 (e.g., as measured in a direction orthogonal to height and orthogonal to an axis extending through the arm from a center of the center conductor 218). In some instances, an arm portion can have a width that becomes narrower in stages, before becoming wider at an end portion. In some instances, a width of an arm portion can be configured to compensate for differing dielectric constants in an environment of the center conductor 218 (e.g., dielectrics 214A-C, other circulator components, vacuum, etc.). For example, an end portion of each arm can in some instances be exposed (e.g., not fully sandwiched between dielectrics, as further depicted in FIG. 3) to facilitate soldering of an electrical contact (e.g., pin, etc.) to each arm of the center conductor 218. In such instances, a width of the arm portion can be configured to compensate for differing dielectric constants of the environments surrounding the exposed end portion and unexposed portions of the arm. In some instances, a center conductor 218 (including, e.g., a central junction portion) can have a shape having three-fold rotational symmetry. In some instances, a depiction in FIG. 2 of a shape of the center conductor can be approximately to scale. Other shapes are possible.

FIG. 3 is a top-down view of part of an example stripline circulator, including a plurality of example stripline components placed on top of the example components depicted in FIG. 2. A plurality of dielectrics 314A-C can be placed on top of a center conductor 218 (e.g., directly above dielectrics 214A-C, etc.). A ferrite 316 can be placed on top of a center conductor 218 (e.g., directly above ferrite 216, etc.). In some instances, an example circulator can comprise the components depicted in FIG. 3, along with a second ground structure 102 on top of the components depicted in FIG. 3.

In some instances, dielectrics 314A-C can be, comprise, be similar to (e.g., same as), or otherwise share one or more (e.g., almost all) properties with the dielectrics 214A-C. In some instances, each dielectric 314A-C can have a length 319 that is different from a corresponding length of a dielectric 214A-C. In this manner, for instance, a portion of the center conductor 218 can be exposed to enable attaching or connecting (e.g., soldering, etc.) the center conductor 218 to another conductive component (e.g., pin, port, etc.). In some instances, dielectrics 314A-C can be otherwise identical to dielectrics 214A-C (e.g., in every respect other than length, etc.).

In some instances, ferrite 316 can be, comprise, be similar to (e.g., same as), or otherwise share one or more (e.g., all) properties with the ferrite 216.

In some instances, a ferrite 316 and dielectrics 314A-C can be inserted into a stripline cavity 104 of a second ground structure 102. In some instances, the insertion can be done in a manner similar to (e.g., same as) a manner described with respect to FIG. 2 for inserting ferrite 216 and dielectrics 214A-C into a first ground structure 102 (e.g., using vacuum grease, etc.).

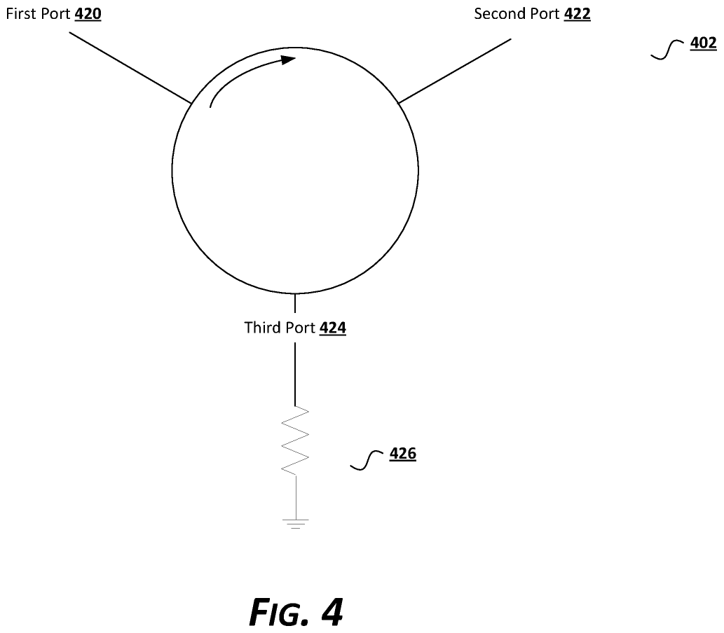

FIG. 4 depicts a schematic view of an example isolator circuit 402, in which a stripline circulator can be used to provide non-reciprocal signal transmission and reverse isolation (e.g., isolation from any noise traveling in a direction opposite an intended signal transmission). The isolator circuit can comprise a stripline circulator having a first port 420, a second port 422, and a third port 424, along with a resistive terminator 426. In some instances, a quantum computing system can include one or more isolator circuits 402 to provide reverse isolation to protect one or more quantum computing components (e.g., qubits, Josephson junctions, etc.) from various kinds of noise.

The first port 420, second port 422, and third port 424 can be, for example, respective ports (e.g., connectors, terminals, etc.) connected to or comprising respective arms of a center conductor 218 of a stripline circulator. In some instances, a ferrite 216 of the stripline circulator can be magnetized (e.g., according to existing methods) to provide a static magnetic bias field. In some instances, a magnetic bias field can cause non-reciprocal signal transmission behavior in the stripline circulator. For example, in some instances, a microwave or RF signal entering the first port 420 can exit the second port 422; a microwave or RF signal entering the second port 422 can exit the third port 424; and a microwave or RF signal entering the third port 424 can exit the first port 420. In this manner, for instance, a stripline circulator can transmit a signal from the first port 420 to the second port 422, without transmitting a reverse signal from the second port 422 to the first port 420. Although FIGS. 1-4 depict circulators having three ports (and three center conductor 218 arms, etc.), other numbers of ports (e.g., four, etc.) are possible without going outside the scope of the present disclosure.

The resistive terminator 426 can comprise, for example, a resistor component (e.g., standard or existing resistor component) connected to a ground. In combination with the non-reciprocal signal transmission described above, the resistive terminator can further provide reverse isolation for the first port 420, such that the first port 420 does not receive unwanted transmissions (e.g., noise) associated with the second port 422 or third port 424.

In some instances, an isolator circuit 402 can comprise a plurality (e.g., three, etc.) of stripline circulators connected in series. For example, a first port 420 of a second stripline circulator can be connected to a second port 422 of a first stripline circulator, such that a signal that enters the first port 420 of the first stripline circulator can exit the second port 422 of the second stripline circulator, while the first port 420 of the first stripline circulator can be isolated from reverse signal transmission (e.g., noise). In some instances, each third port 424 of the plurality of stripline circulators can be connected to a resistive terminator 426 (e.g., 50 ohm terminator, etc.). In some instances, a plurality of stripline circulators connected in series can share one or more ground structures 102 (e.g., ground plane structure having three central junction cavities 106D housing three ferrites 216; seven or nine arm cavities 106A-C housing seven or nine dielectrics 214A-C; etc.). In some instances, an isolator circuit 402 can comprise one or more additional circuits or components (e.g., integrated parametric amplifier, integrated band-pass filter such as combline band-pass filter, etc.). In some instances, a quantum computing system can include one or more isolator circuits 402 to provide reverse isolation for one or more quantum computing components (e.g., qubits, etc.). For example, in some instances, a quantum computing system can include an isolator circuit 402 between a qubit (e.g., connected to a first port 420) and a readout component or measurement component (e.g., readout resonator connected to a second port 422, etc.) to provide reverse isolation for the qubit.

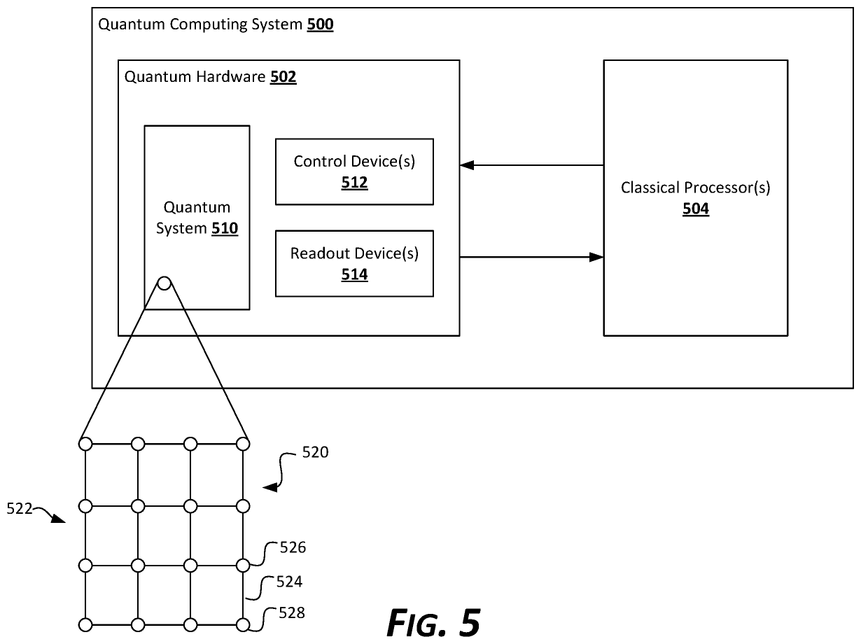

FIG. 5 depicts an example quantum computing system 500. The example system 500 is an example of a system on one or more classical computers or quantum computing devices in one or more locations, in which the systems, components, and techniques described below can be implemented. Those of ordinary skill in the art, using the disclosures provided herein, will understand that other quantum computing structures or systems can be used without deviating from the scope of the present disclosure.

The system 500 includes quantum hardware 502 in data communication with one or more classical processors 504. The quantum hardware 502 includes components for performing quantum computation. For example, the quantum hardware 102 includes a quantum system 510, control device(s) 512, and readout device(s) 514 (e.g., readout resonator(s)). The quantum system 510 can include one or more multi-level quantum subsystems, such as a register of qubits. In some implementations, the multi-level quantum subsystems can include superconducting qubits, such as flux qubits, charge qubits, transmon qubits, gmon qubits, etc.

The type of multi-level quantum subsystems that the system 500 utilizes may vary. For example, in some cases it may be convenient to include one or more readout device(s) 514 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots or phosphorus impurity qubits.

Quantum circuits may be constructed and applied to the register of qubits included in the quantum system 510 via multiple control lines that are coupled to one or more control devices 512. Example control devices 512 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 512 may be configured to operate on the quantum system 510 through one or more respective control parameters (e.g., one or more physical control parameters). For example, in some implementations, the multi-level quantum subsystems may be superconducting qubits and the control devices 512 may be configured to provide control pulses to control lines to generate magnetic fields to adjust the frequency of the qubits.

The quantum hardware 502 may further include readout devices 514 (e.g., readout resonators). Measurement results 508 obtained via measurement devices may be provided to the classical processors 504 for processing and analyzing. In some implementations, the quantum hardware 502 may include a quantum circuit and the control device(s) 512 and readout devices(s) 514 may implement one or more quantum logic gates that operate on the quantum system 502 through physical control parameters (e.g., microwave pulses) that are sent through wires included in the quantum hardware 502. Further examples of control devices include arbitrary waveform generators, wherein a DAC (digital to analog converter) creates the signal.

The readout device(s) 514 may be configured to perform quantum measurements on the quantum system 510 and send measurement results 508 to the classical processors 504. In addition, the quantum hardware 502 may be configured to receive data specifying physical control qubit parameter values 506 from the classical processors 504. The quantum hardware 502 may use the received physical control qubit parameter values 506 to update the action of the control device(s) 512 and readout devices(s) 514 on the quantum system 510. For example, the quantum hardware 502 may receive data specifying new values representing voltage strengths of one or more DACs included in the control devices 512 and may update the action of the DACs on the quantum system 510 accordingly. The classical processors 504 may be configured to initialize the quantum system 510 in an initial quantum state, e.g., by sending data to the quantum hardware 502 specifying an initial set of parameters 506.

The readout device(s) 514 can take advantage of a difference in the impedance for the |0> and |1> states of an element of the quantum system, such as a qubit, to measure the state of the element (e.g., the qubit). For example, the resonance frequency of a readout resonator can take on different values when a qubit is in the state |0> or the state |1>, due to the nonlinearity of the qubit. Therefore, a microwave pulse reflected from the readout device 514 carries an amplitude and phase shift that depend on the qubit state. In some implementations, a Purcell filter can be used in conjunction with the readout device(s) 514 to impede microwave propagation at the qubit frequency.

In some implementations, the quantum system 510 can include a plurality of qubits 520 arranged, for instance, in a two-dimensional grid 522. For clarity, the two-dimensional grid 522 depicted in FIG. 1 includes 16 qubits arranged in a square formation, however in some implementations the system 510 may include a smaller or a larger number of qubits. In some embodiments, the multiple qubits 520 can interact with each other through multiple qubit couplers, e.g., qubit coupler 524. The qubit couplers can define nearest neighbor interactions between the multiple qubits 520. In some implementations, the strengths of the multiple qubit couplers are tunable parameters. In some cases, the multiple qubit couplers included in the quantum computing system 500 may be couplers with a fixed coupling strength. In some implementations, the multiple qubits 520 may include data qubits, such as qubit 526 and measurement qubits, such as qubit 528. A data qubit is a qubit that participates in a computation being performed by the system 500. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 520 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 520 can be chosen before a computation is performed by the calibration system. Some operating frequencies are better than other operating frequencies. One metric for assessing how good a particular operating frequency is for a particular qubit is energy relaxation time (T1) for the qubit at the frequency. Lower energy relaxation times can lead to larger quantum computational errors.

In various implementations, the example system 500 can be implemented as a client device, a server device, or both. The example system 500 can be implemented as part of a distributed computing system. The example system 500 can be implemented along with other example systems, which may be the same or different. The example system 500 can be implemented in a server farm or other facility that operates multiple computing systems to provide computational services to or on behalf of a plurality of client systems. Advantageously, techniques according to example aspects of the present disclosure can provide for improved calibration and maintenance of computing facilities, increasing service uptime, decreasing failure rates, etc.

### Example Methods

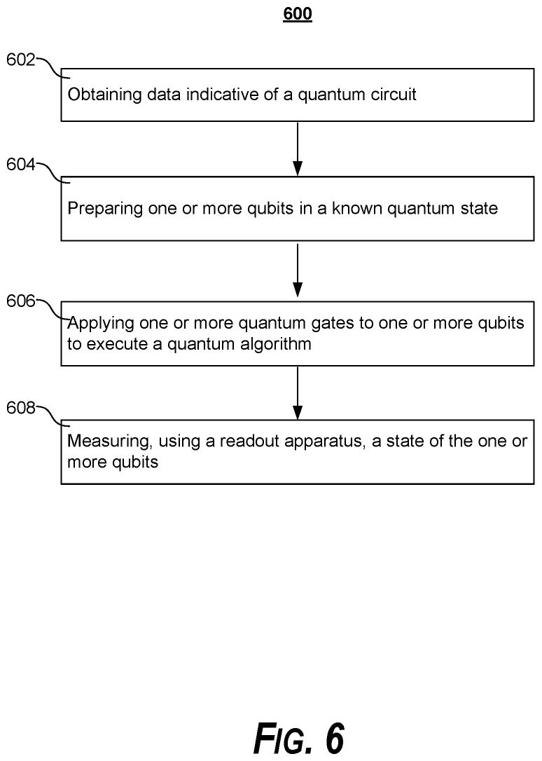

FIG. 6 depicts an example method 600 for performing a quantum computation using a quantum circuit according to example aspects of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure. The method 700 can be implemented by any suitable computing system, such as a quantum computing system including quantum hardware in communication with one or more quantum control devices, such as quantum computing system 500 of FIG. 5.

At 602, example method 600 can include obtaining data indicative of a quantum circuit. Obtaining data can include, for example, receiving data from a computing device (e.g. user device, server device); receiving data from a user (e.g. via input/output device); reading data from one or more non-transitory computer-readable media; generating data (e.g. using an algorithm); etc. Data indicative of a quantum circuit can include, for example, a circuit design, circuit diagram, one or more unitary matrices, software code (e.g. quantum software code in a quantum computing language), etc.

At 604, example method 600 can include preparing one or more qubits in a known quantum state. Preparing one or more qubits in a known quantum state can include, for example, preparing one or more qubits in a known basis state (e.g. by manipulating a plurality of qubits such that qubits characterized by a particular basis state, e.g. |0> or |1>, can be separated from qubits not characterized by that basis state (e.g. physically separated, separately identified, etc.). Preparing one or more qubits in a known quantum state can include, for example, using a control device 512 to perform quantum gating to generate a known multi-qubit basis state. Preparing one or more qubits can include using a control device 512 in a manner described with respect to FIG. 5.

At 606, example method 600 can include applying one or more quantum gates to one or more qubits to execute a quantum algorithm. For example, in some instances control devices 512 can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc., in a manner described with respect to FIG. 5

At 608, example method 600 can include measuring, using a readout apparatus, a state of at least one of the one or more qubits. The readout apparatus can be, for example, a readout device 514, and step 606 can in some instances be performed in a manner described with respect to FIG. 5.

### ADDITIONAL DISCLOSURE

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs (e.g., one or more modules of digital and/or quantum computer program instructions encoded on a tangible non-transitory storage medium for execution by, or to control the operation of, data processing apparatus). The digital and/or quantum computer storage medium can be a machine-readable storage device, a machine-readable storage substrate, a random or serial access memory device, one or more qubits/qubit structures, or a combination of one or more of them. Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit (i.e., a system that defines the unit of quantum information). It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states (e.g., qubits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc.

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

What is claimed is:

1. A stripline circulator comprising:
a first ground structure having one or more cavities;
one or more dielectrics inside the one or more cavities;
at least one center conductor;
a first port;
a second port; and
a third port;
wherein the stripline circulator is characterized by non-reciprocal signal transmission behavior comprising:
responsive to a first signal being provided as an input signal to the first port, the second port provides the first signal as an output signal; and
responsive to a second signal being provided as the input signal to the second port, the third port provides the second signal as the output signal.

2. The stripline circulator of claim 1, further comprising:
a second ground structure; and
a conductive gasket between the first ground structure and the second ground structure.

3. The stripline circulator of claim 2, wherein the conductive gasket is light-tight.

4. The stripline circulator of claim 1, wherein the one or more dielectrics are first dielectrics, and further comprising:
a second ground structure having one or more second cavities; and
one or more second dielectrics inside the one or more second cavities.

5. The stripline circulator of claim 4, wherein:
at least one of the one or more first dielectrics has a first length;
at least one of the one or more second dielectrics has a second length; and
wherein the first length is longer than the second length;
and further comprising one or more electrical contacts connected to the at least one center conductor.

6. The stripline circulator of claim 5, wherein:
the at least one center conductor has a first width at a point where at least one of the one or more electrical contacts is connected;
the at least one center conductor has a second width at a point where the at least one center conductor is between a first dielectric and a second dielectric; and
wherein the first width is different from the second width.

7. The stripline circulator of claim 1, further comprising:
at least one ferrite inside the one or more cavities.

8. The stripline circulator of claim 1, further comprising vacuum grease inside the one or more cavities.

9. The stripline circulator of claim 1, wherein the stripline circulator is characterized by a minimum cavity mode greater than or equal to 12 GHz.

10. A quantum computing system comprising:
a plurality of qubits;
a quantum logic circuit configured to perform one or more quantum operations on the plurality of qubits; and
a stripline circulator, wherein the stripline circulator comprises:
a first ground structure having one or more cavities;
one or more dielectrics inside the one or more cavities; and
at least one center conductor.

11. The quantum computing system of claim 10, wherein the stripline circulator further comprises:
a second ground structure; and
a conductive gasket between the first ground structure and the second ground structure.

12. The quantum computing system of claim 11, wherein the conductive gasket is light-tight.

13. The quantum computing system of claim 10, wherein the one or more dielectrics are first dielectrics, and the stripline circulator further comprises:
A second ground structure having one or more second cavities; and
one or more second dielectrics inside the one or more second cavities.

14. The quantum computing system of claim 13, wherein:
at least one of the one or more first dielectrics has a first length;
at least one of the one or more second dielectrics has a second length; and
wherein the first length is longer than the second length;
and further comprising one or more electrical contacts connected to the at least one center conductor.

15. The quantum computing system of claim 14, wherein:
the at least one center conductor has a first width at a point where at least one of the one or more electrical contacts is connected;
the at least one center conductor has a second width at a point where the at least one center conductor is between a first dielectric and a second dielectric; and
wherein the first width is different from the second width.

16. The quantum computing system of claim 10, wherein the stripline circulator further comprises at least one ferrite inside the one or more cavities.

17. The quantum computing system of claim 10, wherein the stripline circulator further comprises vacuum grease inside the one or more cavities.

18. The quantum computing system of claim 10, wherein the stripline circulator is characterized by a minimum cavity mode greater than 12 GHz.

19. A method for tuning a stripline circulator, comprising:
adjusting a contact pressure between a first ground of the stripline circulator and a second ground of the stripline circulator, such that an impedance between the first ground and the second ground is increased or reduced.

20. The method of claim 19, wherein adjusting a contact pressure comprises loosening or tightening an exterior actuator of the stripline circulator.
